(19) United States
(12) Patent Application Publication
(10) Pub. No.: US 2019/0023601 A1
(43) Pub. Date: Jan. 24, 2019

(54) HEATING STRUCTURE FOR ENERGY-SAVING HOT BENDER AND ENERGY-SAVING HOT BENDER CONTAINING THE SAME

(71) Applicant: Wing Tak Lee Silicone Rubber Technology (Shenzhen) Co., Ltd, Shenzhen (CN)

(72) Inventor: Tak Nam LIU, Shenzhen (CN)

(21) Appl. No.: 15/657,237

(22) Filed: Jul. 24, 2017

(51) Int. Cl. C03B 23/03; C03B 23/023; C03B 25/08; B29C 51/42; B29C 51/46

(52) U.S. Cl. CPC C03B 23/0307; C03B 23/0235; B29C 51/46; C03B 25/08; B29C 51/421; C03B 23/0305

(57) ABSTRACT

The present invention discloses a heating structure for an energy-saving hot bender, which comprises a heating chamber, a connecting rod, a drive mechanism and a hot bending mould moving passage, wherein the connecting rod is arranged on one side of the hot bending mould moving passage, the hot bending mould moving passage and the connecting rod pass through the heating chamber, the drive mechanism is connected with one side of the connecting rod and is capable of driving the connecting rod to rotate, the connecting rod is provided with a plurality of fastener groups, each of the fasteners group comprises two fasteners fixed at opposite positions, and the fasteners are sleeved on the connecting rod.

### TECHNICAL FIELD

The disclosure relates to the fields of machinery and mobile phone accessories, and in particular, to a heating structure for an energy-saving hot bender and an energy-saving hot bender containing the heating structure.

### BACKGROUD

Mobile phone has become the most popular electronic equipment in people's daily life, in particular, the appearance of smart phone with touch screen changes the usage habits of people for mobile phones. For a mobile phone with touch screen, the touch screen is the mostly frequently used part of the mobile phone. As the mobile phone gets larger and larger in size, the screen also gets bigger and bigger, therefore, in order to protect the screen of a mobile phone, screen film appears, which can effectively protect the screen of a mobile phone.

With the development of the screen of mobile phone, the screen of mobile phone develops from a flat display screen to a curved display screen; in order to protect the curved display screen, curved screen film appears too. The key part of the curved screen film is a curved tempered glass film, the transformation of a flat plane to a curved plane needs to be realized by a hot bender, the existing hot benders have a single heating structure, and the adoption of the single heating structure consumes high energy.

### SUMMARY

The disclosure aims to provide a heating structure for an energy-saving hot bender and an energy-saving hot bender containing the heating structure, which mainly solve the problem of high energy consumption in existing technologies.

In order to solve the above technical problem, the disclosure provides a heating structure for an energy-saving hot bender, including: a heating chamber, a connecting rod, a drive mechanism and a hot bending mould moving passage; the connecting rod is arranged on one side of the hot bending mould moving passage, the hot bending mould moving passage and the connecting rod pass through the heating chamber, the drive mechanism is connected with one side of the connecting rod and is capable of driving the connecting rod to rotate, the connecting rod is provided with a plurality of fastener groups, each of the fastener groups includes two fasteners fixed at opposite positions, and the fasteners are sleeved on the connecting rod.

The heating chamber includes: an outer wall, a first depressing assembly, a second depressing assembly and a third depressing assembly that are arranged on the upper part of the outer wall, a first rising assembly, a second rising assembly and a third rising assembly that are on the lower part of the outer wall; the position of the first depressing assembly corresponds to the position of the first rising assembly, the position of the second depressing assembly corresponds to the position of the second rising assembly, and the position of the third depressing assembly corresponds to the position of the third rising assembly; the depressing assembly includes: a depressing cylinder and a heating ring; the heating ring is fixed on a moveable side of the depressing cylinder, the hollow part of the heating ring is larger than the hot bending mould; the rising assembly includes: a rising cylinder and a support plate; and the support plate is fixed to a moveable side of the rising cylinder.

Optionally, the outer wall is further provided with at least one transparent window.

Optionally, the inner side of the outer wall is further provided with a thermal insulating layer.

Optionally, the heating chamber further includes a temperature control circuit, wherein:

one end of the heating ring is connected to one end of a switch K1, the other end of the switch K1 is connected to a positive electrode of a power supply, a negative electrode of the power supply is connected to one end of a first resistor, the other end of the first resistor is connected to the other end of the heating ring, the other end of the first resistor is further connected to one end of a pull-in switch JAK1 of a relay A1, one end of a pull-in switch JBK1 of a relay B1 and one end of a pull-in switch JCK of a relay C, the other end of the pull-in switch JAK1 is connected to one end of a resistor RA, the other end of the pull-in switch JBK1 is connected to one end of a resistor RB, the other end of the pull-in switch JCK is connected to one end of a resistor RC, the other ends of the resistors RA, RB and RC are connected to the negative electrode of the power supply.

The one end of the switch K1 is connected to a port 1 of a rectifier bridge, a port 2 of the rectifier bridge is connected to one end of a thermal resistor RT, the other end of the thermal resistor RT is connected to one end of a second resistor, the other end of the second resistor is grounded, a port 3 of the rectifier bridge is connected to the negative electrode of the power supply, and a port 4 of the rectifier bridge is grounded.

The other end of the thermal resistor RT is connected to one end of a pull-in switch JBK3 of a relay B3, one end of a pull-in switch JBK2 of a relay B2 and a positive input end of a comparator C; the other end of the pull-in switch JBK3 is connected to one end of a pull-in switch JAK2 of a relay A2, the other end of the pull-in switch JAK2 is connected to a positive input end of a comparator A, a negative input end of the comparator A is connected to a first voltage source VCC1, a negative input end of the comparator C is connected to a third voltage source VCC3, the pull-in switch JBK2 is connected to a positive input end of a comparator B, and a negative input end of the comparator B is connected to a second voltage source VCC2.

An output end of the comparator A is connected to a base of a triode QA, a collector of the triode QA is connected to a first voltage source VCC1, an emitter of the triode QA is connected to one end of a coil ZA1 of a relay A1, the other end of the coil ZA1 is connected to one end of a third resistor, and the other end of the third resistor is grounded.

An output end of the comparator B is connected to a base of a triode QB1, a collector of the triode QB1 is connected to a second voltage source VCC2, an emitter of the triode QB1 is connected to one end of a coil ZB1 of a relay Bl, the other end of the coil ZB1 is connected to one end of a fourth resistor, the other end of the fourth resistor is grounded, the other end of the coil ZB1 is further connected to an input end of a first non-gate circuit, an output end of the first non-gate circuit is connected to a base of a triode QB2, a collector of the triode QB2 is connected to a second voltage source VCC2, an emitter of the triode QB2 is connected to one end of a coil ZA2 of a relay A2, the other end of the coil ZA2 is connected to one end of a fifth resistor, and the other end of the fifth resistor is grounded.

An output end of the comparator C is connected to a base of a triode QC1, a collector of the triode QC1 is connected to a third voltage source VCC3, an emitter of the triode QC1 is connected to one end of a coil ZC of a relay C, the other end of the coil ZC is connected to one end of a sixth resistor, the other end of the sixth resistor is grounded, the other end of the coil ZC is further connected to an input end of a second non-gate circuit, an output end of the second non-gate circuit is connected to a base of a triode QC2, a collector of the triode QC2 is connected to a third voltage source VCC3, an emitter of the triode QC2 is connected to one end of a coil ZB2 of a relay B2, the other end of the coil ZB2 is connected to one end of a coil ZB3 of a relay B3, the other end of the coil ZB3 is connected to one end of a seventh resistor, and the other end of the seventh resistor is grounded.

Furthermore, VCC1<VCC2<VCC3

According to a second aspect, an energy-saving hot bender is provided, which includes a heating structure; the heating structure includes: a heating chamber, a connecting rod, a drive mechanism and a hot bending mould moving passage; the connecting rod is arranged on one side of the hot bending mould moving passage, the hot bending mould moving passage and the connecting rod pass through the heating chamber, the drive mechanism is connected with one side of the connecting rod and is capable of driving the connecting rod to rotate, the connecting rod is provided with a plurality of fastener groups, each of the fastener groups includes two fasteners fixed at opposite positions, and the fasteners are sleeved on the connecting rod.

The heating chamber includes: an outer wall, a first depressing assembly, a second depressing assembly and a third depressing assembly that are arranged on the upper part of the outer wall, a first rising assembly, a second rising assembly and a third rising assembly that are arranged on the lower part of the outer wall; the position of the first depressing assembly corresponds to the position of the first rising assembly, the position of the second depressing assembly corresponds to the position of the second rising assembly, and the position of the third depressing assembly corresponds to the position of the third rising assembly; the depressing assembly includes: a depressing cylinder and a heating ring; the heating ring is fixed on a moveable side of the depressing cylinder, the hollow part of the heating ring is larger than the hot bending mould; the rising assembly includes: a rising cylinder and a support plate; and the support plate is fixed to a moveable side of the rising cylinder.

Optionally, the outer wall is further provided with at least one transparent window.

Optionally, the inner side of the outer wall is further provided with a thermal insulating layer.

Optionally, the heating chamber further includes a temperature control circuit, which includes:

one end of the heating ring is connected to one end of a switch K1, the other end of the switch K1 is connected to a positive electrode of a power supply, a negative electrode of the power supply is connected to one end of a first resistor, the other end of the first resistor is connected to the other end of the heating ring, the other end of the first resistor is further connected to one end of a pull-in switch JAK1 of a relay A1, one end of a pull-in switch JBK1 of a relay B1 and one end of a pull-in switch JCK of a relay C, the other end of the pull-in switch JAK1 is connected to one end of a resistor RA, the other end of the pull-in switch JBK1 is connected to one end of a resistor RB, the other end of the pull-in switch JCK is connected to one end of a resistor RC, the other ends of the resistors RA, RB and RC are connected to the negative electrode of the power supply.

The one end of the switch K1 is connected to a port 1 of a rectifier bridge, a port 2 of the rectifier bridge is connected to one end of a thermal resistor RT, the other end of the thermal resistor RT is connected to one end of a second resistor, the other end of the second resistor is grounded, a port 3 of the rectifier bridge is connected to the negative electrode of the power supply, and a port 4 of the rectifier bridge is grounded.

The other end of the thermal resistor RT is connected to one end of a pull-in switch JBK3 of a relay B3, one end of a pull-in switch JBK2 of a relay B2 and a positive input end of a comparator C; the other end of the pull-in switch JBK3 is connected to one end of a pull-in switch JAK2 of a relay A2, the other end of the pull-in switch JAK2 is connected to a positive input end of a comparator A, a negative input end of the comparator A is connected to a first voltage source VCC1, a negative input end of the comparator C is connected to a third voltage source VCC3, the pull-in switch JBK2 is connected to a positive input end of a comparator B, and a negative input end of the comparator B is connected to a second voltage source VCC2.

An output end of the comparator A is connected to a base of a triode QA, a collector of the triode QA is connected to a first voltage source VCC1, an emitter of the triode QA is connected to one end of a coil ZA1 of a relay A1, the other end of the coil ZA1 is connected to one end of a third resistor, and the other end of the third resistor is grounded.

An output end of the comparator B is connected to a base of a triode QB1, a collector of the triode QB1 is connected to a second voltage source VCC2, an emitter of the triode QB1 is connected to one end of a coil ZB1 of a relay Bl, the other end of the coil ZB1 is connected to one end of a fourth resistor, the other end of the fourth resistor is grounded, the other end of the coil ZB1 is further connected to an input end of a first non-gate circuit, an output end of the first non-gate circuit is connected to a base of a triode QB2, a collector of the triode QB2 is connected to a second voltage source VCC2, an emitter of the triode QB2 is connected to one end of a coil ZA2 of a relay A2, the other end of the coil ZA2 is connected to one end of a fifth resistor, and the other end of the fifth resistor is grounded.

An output end of the comparator C is connected to a base of a triode QC1, a collector of the triode QC1 is connected to a third voltage source VCC3, an emitter of the triode QC1 is connected to one end of a coil ZC of a relay C, the other end of the coil ZC is connected to one end of a sixth resistor, the other end of the sixth resistor is grounded, the other end of the coil ZC is further connected to an input end of a second non-gate circuit, an output end of the second non-gate circuit is connected to a base of a triode QC2, a collector of the triode QC2 is connected to a third voltage source VCC3, an emitter of the triode QC2 is connected to one end of a coil ZB2 of a relay B2, the other end of the coil ZB2 is connected to one end of a coil ZB3 of a relay B3, the other end of the coil ZB3 is connected to one end of a seventh resistor, and the other end of the seventh resistor is grounded.

Furthermore, VCC1<VCC2<VCC3.

In the technical scheme provided in the disclosure, after the feed structure sends hot bending moulds to the hot bending mould moving passage, each group of fasteners grips a hot bending mould to move, when the hot bending mould moves to a first position (that is, the positions of the first depressing assembly and the first rising assembly), the depressing assembly and the rising assembly act simultaneously and send the hot bending mould to the hollow part of the heating ring to heat, similarly, second heating and third heating are conducted; this equipment changes the single heating into three steps of heating, and this change is capable of adjusting temperature, for example, if the first heating time is not enough, adjustment may be conducted through subsequent heating; in addition, the heating ring provided here merely is to heat the circumference of the hot bending mould; since the middle part of a curved screen film needs no heating and only the circumference needs hot bending, it is only needed to heat the circumference, without heating the middle part; therefore, energy is saved, this equipment has an energy saving effect.

### BRIEF DESCRIPTION OF THE DRAWINGS

To better describe the technical scheme in the embodiment of the disclosure, the accompanying drawings needed in the implementation are simply illustrated below; obviously, accompanying drawings described hereinafter illustrate some implementations of the disclosure; for the ordinary skill in the field, other accompanying drawings may be obtained according to these accompanying drawings without creative work.

FIG. 1 is a perspective view of a hot bender provided by this application.

FIG. 2 is a structure diagram of a heating structure of an energy-saving hot bender provided by this application.

FIG. 3 is a structure diagram of a material charging component in a feed structure of this application.

FIG. 4 is a structure diagram of a temperature control circuit of the heating structure of this application.

### DESCRIPTION OF THE EMBODIMENTS

A clear and complete description as below is provided to the technical scheme in the embodiments of the disclosure in conjunction with the accompanying drawings in the embodiments of the disclosure. Obviously, the embodiments described hereinafter are simply part embodiments of the disclosure, but all the embodiments. All other embodiments obtained by the ordinary skill in the art based on the embodiments in the disclosure without creative work are intended to be included in the scope of protection of the disclosure.

In the description of the embodiments of the disclosure, it is to be noted that directional or positional relations indicated by terms such as “thickness”, “left”, “right”, “up”, “down”, etc are directional or positional relations shown based on the drawings, merely to conveniently describe the present disclosure and simplify the description, but not to indicate or imply the designated device or element to be constructed and operated in a specific position or in a specific direction; therefore, the used directional terms cannot be understood as a limit to the disclosure.

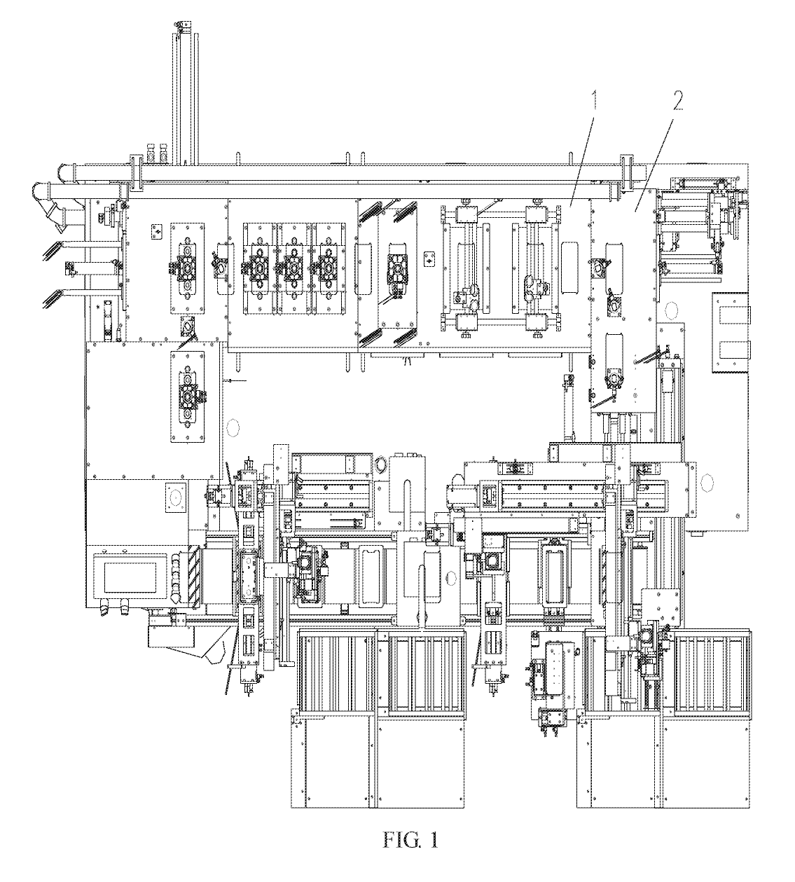

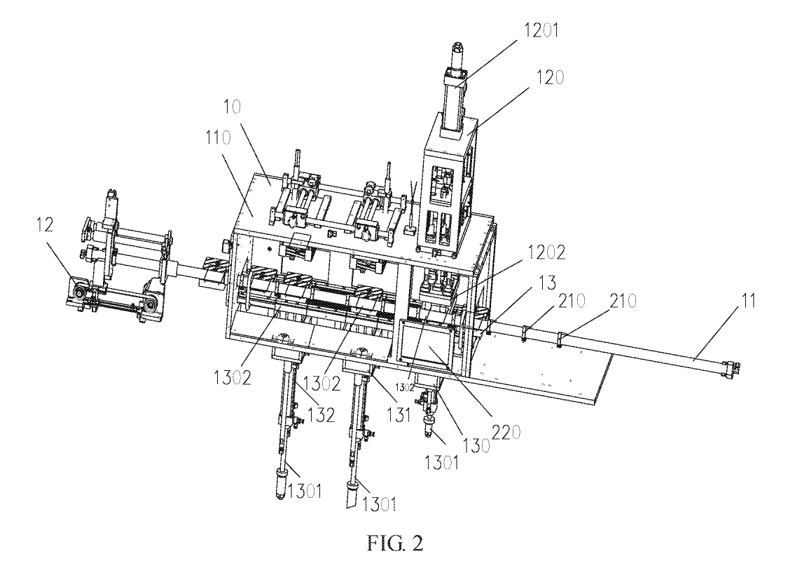

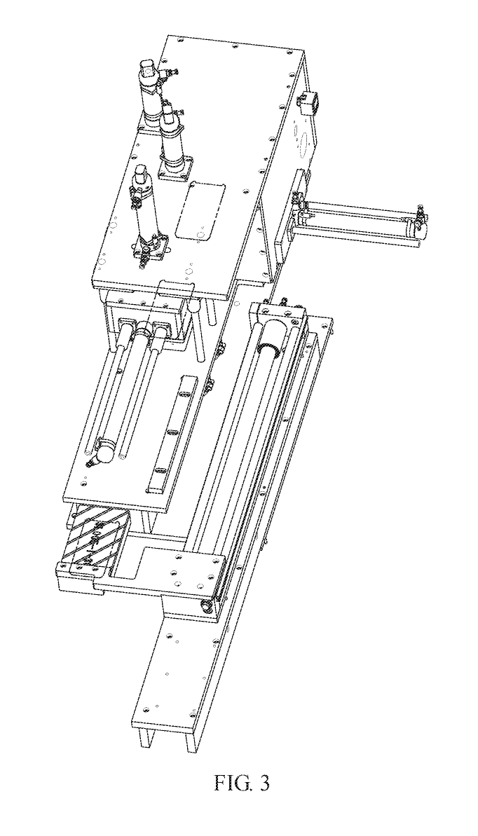

Refer to FIG. 1, which is a structure diagram of a hot bender. As shown in FIG. 1, a heating structure 1 is located behind a feed structure (as shown in FIG. 3). As shown in FIG. 2, the heating structure includes: a heating chamber 10, a connecting rod 11, a drive mechanism 12 and a hot bending mould moving passage 13, wherein the connecting rod 11 is arranged on one side (the left side or the right side, FIG. 2 takes the left side for example) of the hot bending mould moving passage 13, the hot bending mould moving passage 13 and the connecting rod 11 pass through the heating chamber 10, the drive mechanism 12 is connected with one side of the connecting rod 11 and can drive the connecting rod 11 to rotate, the connecting rod 11 is provided with a plurality of fastener groups, each fastener group includes two fasteners 210 having fixed opposite positions, and the fasteners 210 are sleeved on the connecting rod 11.

The heating chamber 10 includes: an outer wall 110, a first depressing assembly 120, a second depressing assembly (not shown) and a third depressing assembly (not shown) that are arranged on the upper part of the outer wall 110, a first rising assembly 130, a second rising assembly 131 and a third rising assembly 132 that are on the lower part of the outer wall 110; the first depressing assembly 120 corresponds to the first rising assembly 130 in position, the second depressing assembly corresponds to the second rising assembly in position, and the third depressing assembly corresponds to the third rising assembly in position; the depressing assembly 120 includes: a depressing cylinder 1201 and a heating ring 1202; the heating ring 1202 is fixed on a moveable side of the depressing cylinder 1201, the hollow part of the heating ring 1202 is larger than the hot bending mould; the rising assembly 130 includes: a rising cylinder 1301 and a support plate 1302; and the support plate 1302 is fixed to a moveable side of the rising cylinder 1301.

The working principle of the hot bender is that: after the feed structure sends hot bending moulds to the hot bending mould moving passage, each group of fasteners grips a hot bending mould to move, when the hot bending mould moves to a first position (that is, the positions of the first depressing assembly and the first rising assembly), the depressing assembly and the rising assembly act simultaneously and send the hot bending mould to the hollow part of the heating ring 1202 to heat, similarly, the second heating and third heating are conducted. This equipment changes the single heating into three steps of heating, and this change is capable of adjusting temperature, for example, if the first heating time is not enough, adjustment may be conducted through subsequent heating; in addition, the heating ring provided here merely is to heat the circumference of the hot bending mould; since the middle part of a curved screen film needs no heating and only the circumference needs hot bending, it is only needed to heat the circumference, without heating the middle part, therefore, energy is saved, this equipment has an energy saving effect.

Optionally, the outer wall 110 is further provided with at least one transparent window 220. The arrangement of the transparent window 220 enables an operator to observe the operation in the heating chamber conveniently.

Optionally, the inner side of the outer wall 110 is further provided with a thermal insulating layer, which is arranged with the purpose of avoiding an operator touching the heating chamber to cause burn, because the temperature of the heating chamber reaches up to hundreds of degree Celsius. If there is no thermal insulating layer provided, although there is air isolation, the transfer of heat is still great, since most parts of the outer wall are made of metal materials, the heat-conducting property is very good, thus the operator is easy to get burned.

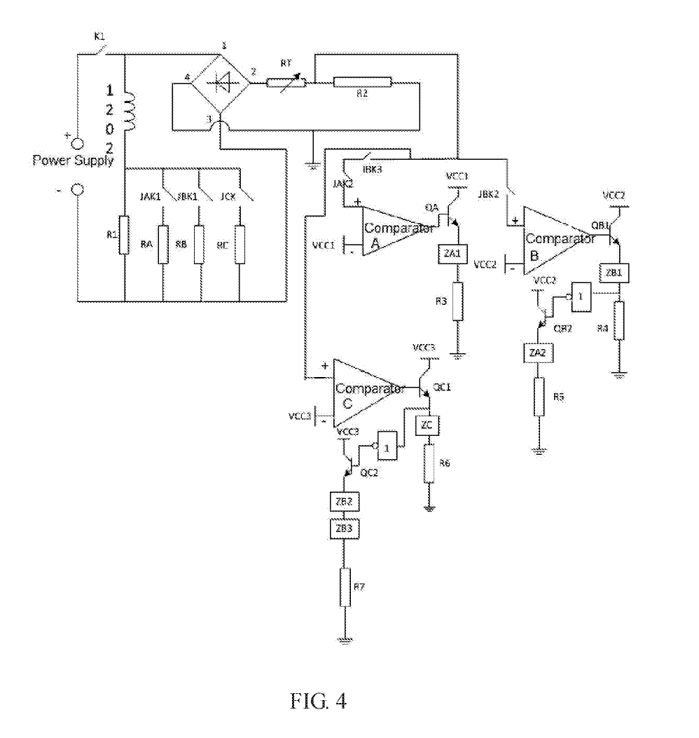

Optionally, the heating chamber 10 further includes a temperature control circuit, which is as shown in FIG. 4, including: one end of the heating ring 1202 is connected to one end of a switch K1, the other end of the switch K1 is connected to a positive electrode of a power supply, a negative electrode of the power supply is connected to one end of a first resistor R1, the other end of the first resistor R1 is connected to the other end of the heating ring 1202, the other end of R1 is further connected to one end of a pull-in switch JAK1 of a relay A1, one end of a pull-in switch JBK1 of a relay B1 and one end of a pull-in switch JCK of a relay C, the other end of the pull-in switch JAK1 is connected to one end of a resistor RA, the other end of the pull-in switch JBK1 is connected to one end of a resistor RB, the other end of the pull-in switch JCK is connected to one end of a resistor RC, the other ends of the resistors RA, RB and RC are connected to the negative electrode of the power supply.

The one end of the switch K1 is connected to a port 1 of a rectifier bridge, a port 2 of the rectifier bridge is connected to one end of a thermal resistor RT, the other end of the thermal resistor RT is connected to one end of a second resistor, the other end of the second resistor is grounded, a port 3 of the rectifier bridge is connected to the negative electrode of the power supply, and a port 4 of the rectifier bridge is grounded.

The other end of the thermal resistor RT is connected to one end of a pull-in switch JBK3 of a relay B3, one end of a pull-in switch JBK2 of a relay B2 and a positive input end of a comparator C, the other end of the pull-in switch JBK3 is connected to one end of a pull-in switch JAK2 of a relay A2, the other end of the pull-in switch JAK2 is connected to a positive input end of a comparator A, a negative input end of the comparator A is connected to a first voltage source VCC1, a negative input end of the comparator C is connected to a third voltage source VCC3, the pull-in switch JBK2 is connected to a positive input end of a comparator B, and a negative input end of the comparator B is connected to a second voltage source VCC2.

An output end of the comparator A is connected to a base of a triode QA, a collector of the triode QA is connected to a first voltage source VCC1, an emitter of the triode QA is connected to one end of a coil ZA1 of a relay A1, the other end of the coil ZA1 is connected to one end of a third resistor R3, and the other end of the third resistor R3 is grounded.

An output end of the comparator B is connected to a base of a triode QB1, a collector of the triode QB1 is connected to a second voltage source VCC2, an emitter of the triode QB1 is connected to one end of a coil ZB1 of a relay Bl, the other end of the coil ZB1 is connected to one end of a fourth resistor R4, the other end of the fourth resistor R4 is grounded, the other end of the coil ZB1 is further connected to an input end of a first non-gate circuit, an output end of the first non-gate circuit is connected to a base of a triode QB2, a collector of the triode QB2 is connected to a second voltage source VCC2, an emitter of the triode QB2 is connected to one end of a coil ZA2 of a relay A2, the other end of the coil ZA2 is connected to one end of a fifth resistor R5, and the other end of the fifth resistor R5 is grounded.

An output end of the comparator C is connected to a base of a triode QC1, a collector of the triode QC1 is connected to a voltage source VCC3, an emitter of the triode QC1 is connected to one end of a coil ZC of a relay C, the other end of the coil ZC is connected to one end of a sixth resistor R6, the other end of the sixth resistor R6 is grounded, the other end of the coil ZC is further connected to an input end of a second non-gate circuit, an output end of the second non-gate circuit is connected to a base of a triode QC2, a collector of the triode QC2 is connected to a third voltage source VCC3, an emitter of the triode QC2 is connected to one end of a coil ZB2 of a relay B2, the other end of the coil ZB2 is connected to one end of a coil ZB3 of a relay B3, the other end of the coil ZB3 is connected to one end of a seventh resistor R7, and the other end of the seventh resistor R7 is grounded.

Optionally, VCC1<VCC2<VCC3.

The working state of the circuit is illustrated below. As the resistance of the thermal resistor varies as a function of temperature, the voltage U2 of the second resistor R2 will vary as a function of temperature, therefore, when the value of U2 is between VCC1 and VCC2, since U2 is less than VCC3, the comparator C outputs a low level, the QC1 is turned off, the pull-in switch JCK of the relay ZC is switched off, the QC2 is conducted on, both the pull-in switch JBK2 of the relay B2 and the pull-in switch JBK3 of the relay B3 are switched on, likewise, for the comparator B, the pull-in switch JBK1 of the relay ZB1 is switched off, the pull-in switch JAK2 of the relay ZA2 is switched on, since U2 is greater than VCC1, the comparator A outputs a high level, the pull-in switch JAK1 of the relay ZA1 is switched on, at this time, the resistor RA is the resistor connected in parallel.

When the value of U2 is between VCC2 and VCC3, since U2 is less than VCC3, the comparator C outputs a low level, the QC1 is turned off, the pull-in switch JCK of the relay ZC is switched off, the QC2 is conducted on, both the pull-in switch JBK2 of the relay B2 and the pull-in switch JBK3 of the relay B3 are switched on, and, for the comparator B, since U2 is greater than VCC2, the comparator B outputs a high level, the pull-in switch JBK1 of the relay ZB1 is switched on, the pull-in switch JAK2 of the relay ZA2 is switched off, since the pull-in switch JAK2 of the comparator A is switched off, the comparator A does not work, thus the resistor connected in parallel is RB.

When the value of U2 is greater than VCC3, the comparator C outputs a high level, the QC1 is conducted on, the pull-in switch JCK of the relay ZC is switched on, the QC2 is turned off, both the pull-in switch JBK2 of the relay B2 and the pull-in switch JBK3 of the relay B3 are switched off, at this time, the resistor connected in parallel is the resistor R3, therefore the temperature control circuit may select which resistor to be connected in parallel according to specific temperatures. Since the resistors connected in parallel have different resistances, impact will be caused to the current of resistance wires, thereby adjusting the temperature, accordingly the temperature control circuit has an advantage of realizing temperature control automatically.

The above are specific implementations of the embodiments of the disclosure. It should be noted that, for the ordinary skill in this art, multiple improvements and modifications may be made without departing from the principle of the embodiments of the disclosure, and these improvements and modifications shall fall into the scope of protection of the disclosure.

What is claimed is:

1. A heating structure for an energy-saving hot bender, comprising: a heating chamber, a connecting rod, a drive mechanism and a hot bending mould moving passage, wherein the connecting rod is arranged on one side of the hot bending mould moving passage, the hot bending mould moving passage and the connecting rod pass through the heating chamber, the drive mechanism is connected with one side of the connecting rod and is capable of driving the connecting rod to rotate, the connecting rod is provided with a plurality of fastener groups, each of the fastener groups comprises two fasteners fixed at opposite positions, and the fasteners are sleeved on the connecting rod,
the heating chamber comprises: an outer wall, a first depressing assembly, a second depressing assembly and a third depressing assembly that are arranged on an upper part of the outer wall, and a first rising assembly, a second rising assembly and a third rising assembly that are arranged on a lower part of the outer wall, wherein a position of the first depressing assembly corresponds to a position of the first rising assembly, a position of the second depressing assembly corresponds to a position of the second rising assembly, and a position of the third depressing assembly corresponds to a position of the third rising assembly, the depressing assembly comprises: a depressing cylinder and a heating ring, wherein the heating ring is fixed on a moveable side of the depressing cylinder, the heating ring has a hollow part that is larger than the hot bending mould, the rising assembly comprises: a rising cylinder and a support plate, wherein the support plate is fixed to a moveable side of the rising cylinder.

2. The heating structure of claim 1, wherein the outer wall is further provided with at least one transparent window.

3. The heating structure of claim 1, wherein the outer wall has an inner side having a thermal insulating layer.

4. The heating structure of claim 1, wherein the heating chamber further comprises a temperature control circuit, wherein:
one end of the heating ring is connected to one end of a switch K1, another end of the switch K1 is connected to a positive electrode of a power supply, a negative electrode of the power supply is connected to one end of a first resistor, another end of the first resistor is connected to another end of the heating ring, the other end of the first resistor is further connected to one end of a pull-in switch JAK1 of a relay A1, one end of a pull-in switch JBK1 of a relay B1 and one end of a pull-in switch JCK of a relay C, another end of the pull-in switch JAK1 is connected to one end of a resistor RA, another end of the pull-in switch JBK1 is connected to one end of a resistor RB, another end of the pull-in switch JCK is connected to one end of a resistor RC, other ends of the resistors RA, RB and RC are connected to the negative electrode of the power supply,
the one end of the switch K1 is connected to a port 1 of a rectifier bridge, a port 2 of the rectifier bridge is connected to one end of a thermal resistor RT, another end of the thermal resistor RT is connected to one end of a second resistor, another end of the second resistor is grounded, a port 3 of the rectifier bridge is connected to the negative electrode of the power supply, and a port 4 of the rectifier bridge is grounded,
another end of the thermal resistor RT is connected to one end of a pull-in switch JBK3 of a relay B3, one end of a pull-in switch JBK2 of a relay B2 and a positive input end of a comparator C; another end of the pull-in switch JBK3 is connected to one end of a pull-in switch JAK2 of a relay A2, another end of the pull-in switch JAK2 is connected to a positive input end of a comparator A, a negative input end of the comparator A is connected to a first voltage source VCC1, a negative input end of the comparator C is connected to a third voltage source VCC3, the pull-in switch JBK2 is connected to a positive input end of a comparator B, and a negative input end of the comparator B is connected to a second voltage source VCC2,
an output end of the comparator A is connected to a base of a triode QA, a collector of the triode QA is connected to the first voltage source VCC1, an emitter of the triode QA is connected to one end of a coil ZA1 of a relay A1, another end of the coil ZA1 is connected to one end of a third resistor, and another end of the third resistor is grounded,
an output end of the comparator B is connected to a base of a triode QB1, a collector of the triode QB1 is connected to the second voltage source VCC2, an emitter of the triode QB1 is connected to one end of a coil ZB1 of a relay Bl, another end of the coil ZB1 is connected to one end of a fourth resistor, another end of the fourth resistor is grounded, the other end of the coil ZB1 is further connected to an input end of a first non-gate circuit, an output end of the first non-gate circuit is connected to a base of a triode QB2, a collector of the triode QB2 is connected to the second voltage source VCC2, an emitter of the triode QB2 is connected to one end of a coil ZA2 of a relay A2, another end of the coil ZA2 is connected to one end of a fifth resistor, and another end of the fifth resistor is grounded,
an output end of the comparator C is connected to a base of a triode QC1, a collector of the triode QC1 is connected to the third voltage source VCC3, an emitter of the triode QC1 is connected to one end of a coil ZC of a relay C, another end of the coil ZC is connected to one end of a sixth resistor, another end of the sixth resistor is grounded, the other end of the coil ZC is further connected to an input end of a second non-gate circuit, an output end of the second non-gate circuit is connected to a base of a triode QC2, a collector of the triode QC2 is connected to the third voltage source VCC3, an emitter of the triode QC2 is connected to one end of a coil ZB2 of a relay B2, another end of the coil ZB2 is connected to one end of a coil ZB3 of a relay B3, another end of the coil ZB3 is connected to one end of a seventh resistor, and another end of the seventh resistor is grounded,
wherein VCC1<VCC2<VCC3.

5. An energy-saving hot bender comprising a heating structure, wherein the heating structure comprises: a heating chamber, a connecting rod, a drive mechanism and a hot bending mould moving passage, wherein the connecting rod is arranged on one side of the hot bending mould moving passage, the hot bending mould moving passage and the connecting rod pass through the heating chamber, the drive mechanism is connected with one side of the connecting rod and is capable of driving the connecting rod to rotate, the connecting rod is provided with a plurality of fastener groups, each of the fastener groups comprises two fasteners fixed at opposite positions, and the fasteners are sleeved on the connecting rod,
the heating chamber comprises: an outer wall, a first depressing assembly, a second depressing assembly and a third depressing assembly that are arranged on an upper part of the outer wall, and a first rising assembly, a second rising assembly and a third rising assembly that are arranged on a lower part of the outer wall, wherein a position of the first depressing assembly corresponds to a position of the first rising assembly, a position of the second depressing assembly corresponds to a position of the second rising assembly, and a position of the third depressing assembly corresponds to a position of the third rising assembly, the depressing assembly comprises: a depressing cylinder and a heating ring, wherein the heating ring is fixed on a moveable side of the depressing cylinder, a hollow part of the heating ring is larger than the hot bending mould, the rising assembly comprises a rising cylinder and a support plate, wherein the support plate is fixed to a moveable side of the rising cylinder.

6. The energy-saving hot bender of claim 5, wherein the outer wall is further provided with at least one transparent window.

7. The energy-saving hot bender of claim 5, wherein the outer wall has an inner side having a thermal insulating layer.

8. The energy-saving hot bender of claim 5, wherein the heating chamber further comprises a temperature control circuit, wherein:
one end of the heating ring is connected to one end of a switch K1, another end of the switch K1 is connected to a positive electrode of a power supply, a negative electrode of the power supply is connected to one end of a first resistor, another end of the first resistor is connected to another end of the heating ring, the other end of the first resistor is further connected to one end of a pull-in switch JAK1 of a relay A1, one end of a pull-in switch JBK1 of a relay B1 and one end of a pull-in switch JCK of a relay C, another end of the pull-in switch JAK1 is connected to one end of a resistor RA, another end of the pull-in switch JBK1 is connected to one end of a resistor RB, another end of the pull-in switch JCK is connected to one end of a resistor RC, other ends of the resistors RA, RB and RC are connected to the negative electrode of the power supply,
the one end of the switch K1 is connected to a port 1 of a rectifier bridge, a port 2 of the rectifier bridge is connected to one end of a thermal resistor RT, another end of the thermal resistor RT is connected to one end of a second resistor, another end of the second resistor is grounded, a port 3 of the rectifier bridge is connected to the negative electrode of the power supply, and a port 4 of the rectifier bridge is grounded,
another end of the thermal resistor RT is connected to one end of a pull-in switch JBK3 of a relay B3, one end of a pull-in switch JBK2 of a relay B2 and a positive input end of a comparator C; another end of the pull-in switch JBK3 is connected to one end of a pull-in switch JAK2 of a relay A2, another end of the pull-in switch JAK2 is connected to a positive input end of a comparator A, a negative input end of the comparator A is connected to a first voltage source VCC1, a negative input end of the comparator C is connected to a third voltage source VCC3, the pull-in switch JBK2 is connected to a positive input end of a comparator B, and a negative input end of the comparator B is connected to a second voltage source VCC2,
an output end of the comparator A is connected to a base of a triode QA, a collector of the triode QA is connected to the first voltage source VCC1, an emitter of the triode QA is connected to one end of a coil ZA1 of a relay A1, another end of the coil ZA1 is connected to one end of a third resistor, and another end of the third resistor is grounded,
an output end of the comparator B is connected to a base of a triode QB1, a collector of the triode QB1 is connected to the second voltage source VCC2, an emitter of the triode QB1 is connected to one end of a coil ZB1 of a relay Bl, another end of the coil ZB1 is connected to one end of a fourth resistor, another end of the fourth resistor is grounded, the other end of the coil ZB1 is further connected to an input end of a first non-gate circuit, an output end of the first non-gate circuit is connected to a base of a triode QB2, a collector of the triode QB2 is connected to the second voltage source VCC2, an emitter of the triode QB2 is connected to one end of a coil ZA2 of a relay A2, another end of the coil ZA2 is connected to one end of a fifth resistor, and another end of the fifth resistor is grounded,
an output end of the comparator C is connected to a base of a triode QC1, a collector of the triode QC1 is connected to the third voltage source VCC3, an emitter of the triode QC1 is connected to one end of a coil ZC of a relay C, another end of the coil ZC is connected to one end of a sixth resistor, another end of the sixth resistor is grounded, the other end of the coil ZC is further connected to an input end of a second non-gate circuit, an output end of the second non-gate circuit is connected to a base of a triode QC2, a collector of the triode QC2 is connected to the third voltage source VCC3, an emitter of the triode QC2 is connected to one end of a coil ZB2 of a relay B2, another end of the coil ZB2 is connected to one end of a coil ZB3 of a relay B3, another end of the coil ZB3 is connected to one end of a seventh resistor, and another end of the seventh resistor is grounded,
wherein VCC1<VCC2<VCC3.
